(19) United States
(12) Patent Application Publication
(10) Pub. No.: US 2017/0221625 A1
(43) Pub. Date: Aug. 3, 2017

(54) MAGNETIC DEVICES INCLUDING LOW AC RESISTANCE FOIL WINDINGS AND GAPPED MAGNETIC CORES

(71) Applicants: Weyman LUNDQUIST, Berkeley, CA (US); Carl CASTRO, Hercules, CA (US); THE TRUSTEES OF DARTMOUTH COLLEGE, Hanover, NH (US); WEST COAST MAGNETICS, Stockton, CA (US)

(72) Inventors: Charles SULLIVAN, West Lebanon, NH (US); Weyman LUNDQUIST, Berkeley, CA (US); Carl CASTRO, Hercules, CA (US)

(21) Appl. No.: 15/502,143

(22) PCT Filed: Aug. 7, 2015
(86) PCT No.: PCT/US2015/044297

§ 371 Date: Feb. 6, 2017

Related U.S. Application Data
(60) Provisional application No. 62/034,278, filed on Aug. 7, 2014.

(51) Int. Cl. H01F 27/28; H01F 27/24

(52) U.S. Cl. CPC H01F 27/2804; H01F 27/24; H01F 2027/2809; H01F 2027/2814

(57) ABSTRACT

A magnetic device having height includes a magnetic core, a first foil winding, and a second foil winding. The magnetic core includes first and second inner posts separated from each other in the height direction by a first inner gap and first and second outer elements separated from each other in the height direction by a first outer gap. The first foil winding is wound around the first inner post without extending along a height of the first inner gap and without extending along a height of the first outer gap. The second foil winding is wound around the second inner post without extending along the height of the first inner gap and without extending along the height of the first outer gap.

### RELATED APPLICATIONS

This application claims benefit of priority to U.S. Provisional Patent Application Ser. No. 62/034,278, filed Aug. 7, 2014, which is incorporated herein by reference.

### BACKGROUND

Magnetic devices, such as inductors and transformers, are widely used in electrical systems. For example, electric power systems use transformers to step up voltage for power transmission and to step down voltage for power distribution. As another example, many switching power converters include inductors for filtering switching waveforms.

Magnetic devices are often used in high frequency applications. For example, one application of magnetic devices is in switching power converters. It is frequently desirable to operate switching power converters at high frequencies to promote fast converter transient response and small component size. However, magnetic device windings often have high effective resistances at high frequencies.

In particular, both skin and proximity effects may cause a winding to have a significantly higher alternating current (AC) resistance than direct current (DC) resistance, where AC resistance refers to the winding's resistance when conducting AC current, and DC resistance refers to the winding's resistance when conducting DC current. The skin effect refers to the tendency for AC current to be confined to an outer portion of the winding's cross-sectional area, such that the winding's effective cross-sectional area is smaller when conducting AC current than when conductive DC current. The proximity effect refers to a magnetic field external to a conductor of the winding inducing eddy currents in the conductor, thereby increasing the conductor's effective resistance. Resistance associated with skin and proximity effects generally increases with increasing operating frequency.

One known technique for minimizing winding AC resistance is to construct the winding out of thin foil, where the foil has a thickness that is less than a skin depth at an intended operating frequency, where the skin depth is a distance from an outer surface of the winding where current density is 37 percent of its value at the outer surface. While this technique can reduce or eliminate resistance increase due to skin effects in some applications, the winding may still be subject to proximity effects from fringing magnetic fields, such as from a magnetic core gap. These proximity effects may cause significant resistance and associated losses in the winding. Consider for example FIG. 1, which is a vertical cross-sectional view of a prior art inductor 100. Inductor 100 includes a magnetic core 102 including inner posts 104 and 106 separated by a gap 108. Gap 108 is included, for example, to minimize likelihood of magnetic saturation and/or to help achieve desired energy storage. A foil winding 110 is wound around inner posts 104 and 106. The relatively high reluctance of gap 108, compared to the reluctance of the remainder of magnetic core 102, causes fringing magnetic flux 112, illustrated by dashed lines, to flow adjacent to gap 108. Fringing magnetic flux 112 induces eddy currents in foil winding 110, thereby causing foil winding 110 to have a relatively high AC resistance.

Techniques for minimizing resistance in gapped magnetic devices including foil windings are disclosed in U.S. Pat. No. 7,701,317 to Sullivan et al (Sullivan '317). Sullivan '317 teaches, in part, a magnetic device including a foil winding formed with one or more cavities, where the foil winding is positioned about the magnetic core such that the cavities are adjacent to the gaps. FIG. 2 shows one example of a magnetic device 200 incorporating techniques from Sullivan '317, where a foil winding 202 forms cavities 204 adjacent to a gap 206. The cavities help minimize the effect of fringing magnetic flux 208 on foil winding 202. Although the techniques disclosed in Sullivan '317 can be very effective, it may be relatively difficult to manufacture a magnetic device including a winding forming the requisite cavities.

### SUMMARY

In an embodiment, a magnetic device having height includes a magnetic core, a first foil winding, and a second foil winding. The magnetic core includes first and second inner posts separated from each other in the height direction by a first inner gap and first and second outer elements separated from each other in the height direction by a first outer gap. The first foil winding is wound around the first inner post without extending along a height of the first inner gap and without extending along a height of the first outer gap. The second foil winding is wound around the second inner post without extending along the height of the first inner gap and without extending along the height of the first outer gap.

In an embodiment, a magnetic device having height includes a magnetic core, a first litz wire winding, and a foil winding. The magnetic core includes a plurality of inner posts, where adjacent inner posts are separated from each other in the height direction by a respective inner gap. A first litz wire winding is wound around the plurality of inner posts, and a foil winding wound around the first litz wire winding.

In an embodiment, a magnetic device having length and height includes a magnetic core, a first foil winding, and a second foil winding. The magnetic core includes first and second inner posts separated from each other in the height direction by a first inner gap. The first foil winding is wound around the first inner post, and the first foil winding forms a plurality of first winding turns, where respective heights of the first winding turns increase with increasing lengthwise distance from the first inner post. The second foil winding is separated from the first foil winding in the height direction. The second foil winding is wound around the second inner post, and the second foil winding forms a plurality of second winding turns, where respective heights of the second winding turns increase with increasing lengthwise distance from the second inner post.

In an embodiment, a magnetic device having height includes a magnetic core and a foil winding. The magnetic core includes (1) first and second end pieces separated from each other in the height direction, (2) an inner post separated from the first end piece in the height direction by an inner gap, and (3) a first outer element separated from the first end piece in the height direction by a first outer gap. The foil winding is wound around the inner post. The foil winding is separated from the first end piece by a first separation distance in the height direction, and the foil winding is separated from the second end piece by a second separation distance in the height direction, where the first separation distance is greater than the second separation distance.

### BRIEF DESCRIPTION OF THE DRAWINGS

FIG. 1 is a vertical cross-sectional view of a prior art inductor.

FIG. 2 is a vertical cross-sectional view of another prior art inductor.

FIG. 3 is a top plan view of a magnetic device including foil windings disposed substantially outside of gap-induced, fringing magnetic flux paths, according to an embodiment.

FIG. 4 is side elevational view of the FIG. 3 magnetic device.

FIG. 5 is a vertical cross-sectional view take along line 3A-3A of FIG. 3.

FIG. 6 is vertical cross-sectional view like that of FIG. 5 and illustrating approximate gap-induced, fringing magnetic flux paths.

FIG. 7 is a vertical cross-sectional view of a magnetic device where some foil winding turns have extended respective heights, according to an embodiment.

FIG. 8 is vertical cross-sectional view like that of FIG. 7 and illustrating approximate gap-induced, fringing magnetic flux paths

FIG. 9 is a vertical cross-sectional view of a magnetic device including a magnetic core without outer gaps, according to an embodiment.

FIG. 10 is a vertical cross-sectional view of a magnetic device where winding turn height increases with lengthwise distance from inner posts, according to an embodiment.

FIG. 11 is a vertical cross-sectional view of a magnetic device similar to that of FIG. 3, but where the magnetic core includes only two outer elements, according to an embodiment.

FIG. 12 is a vertical cross-sectional view of a magnetic device similar to that of FIG. 11, but with additional foil windings, according to an embodiment.

FIG. 13 is a vertical cross-sectional view of a magnetic device similar to that of FIG. 3, but with additional magnetic elements and foil windings, according to an embodiment.

FIG. 14 is a vertical cross-sectional view of a magnetic device similar to that of FIG. 3, but further including a litz wire winding disposed between foil windings, according to an embodiment.

FIG. 15 is a vertical cross-sectional view of a magnetic device including two litz wire windings and a foil winding, according to an embodiment.

FIG. 16 is a vertical cross-sectional view of a magnetic device similar to that of FIG. 15, but where the magnetic core only forms a single gap, according to an embodiment.

FIG. 17 is a vertical cross-sectional view of a magnetic device similar to that of FIG. 16, but where the magnetic core forms multiple inner gaps, according to an embodiment.

FIG. 18 is a top plan view of a magnetic device similar to the FIG. 3 magnetic device, but having a round magnetic core, according to an embodiment.

FIG. 19 is a side elevational view of the FIG. 18 magnetic device.

FIG. 20 is a vertical cross-sectional view of the FIG. 18 magnetic device taken along line 18A-18A of FIG. 18.

FIG. 21 is a horizontal cross-sectional view of the FIG. 18 magnetic device taken along line 19A-19A of FIG. 19.

FIG. 22 is a vertical cross-sectional view of a magnetic device similar to that of FIG. 3, but including four windings.

FIG. 23 is a vertical cross-sectional view of a magnetic device which is similar to that of FIG. 9, but includes four windings.

FIG. 24 is a vertical cross-sectional view of a magnetic device including a single foil winding, according to an embodiment.

FIG. 25 is vertical cross-sectional view like that of FIG. 24 and illustrating approximate gap-induced, fringing magnetic flux paths.

FIG. 26 is a vertical cross-sectional view of a magnetic device, which is similar to the magnetic device of FIGS. 24 and 25, but with a magnetic core including only a single outer element, according to an embodiment.

FIG. 27 is a vertical cross-sectional view of a magnetic device, which is similar to the magnetic device of FIG. 26, but including two windings, according to an embodiment.

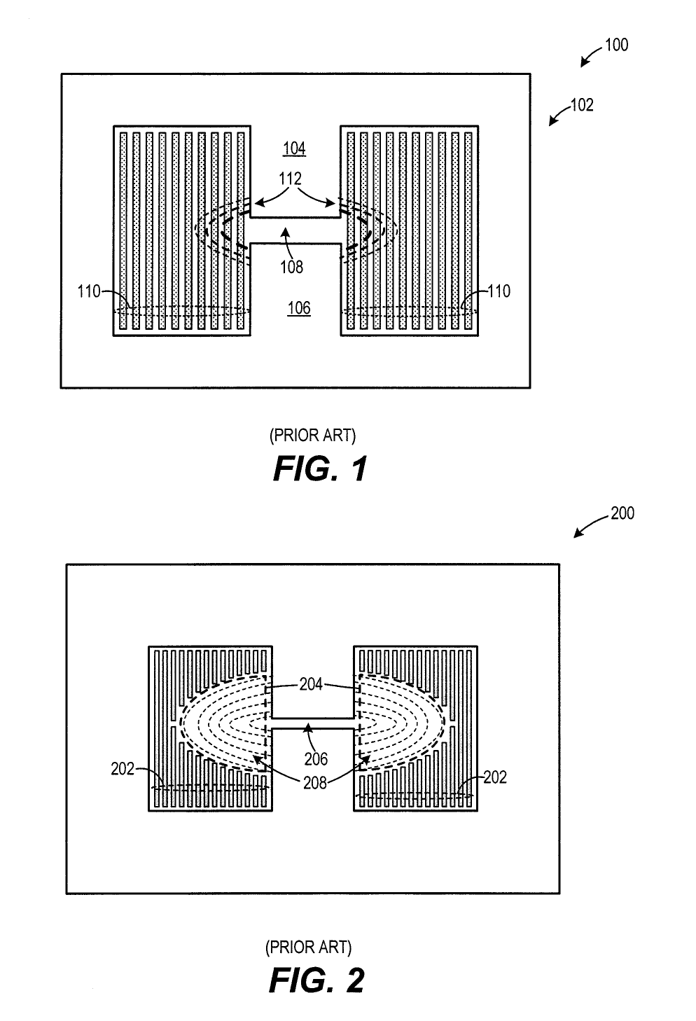

### DETAILED DESCRIPTION OF THE EMBODIMENTS

### Magnetic Devices Including Multiple Foil Windings

Applicants have discovered that low AC resistance can be achieved in foil windings on a gapped magnetic core by using two separate foil windings in place of a single foil winding, with the two foil windings disposed substantially outside of gap-induced, fringing magnetic flux paths. As discussed below, magnetic devices having these characteristics potentially achieve low foil winding AC resistance comparable to that achievable using techniques disclosed in Sullivan '317, without potential manufacturing difficulties associated with forming cavities adjacent to gaps.

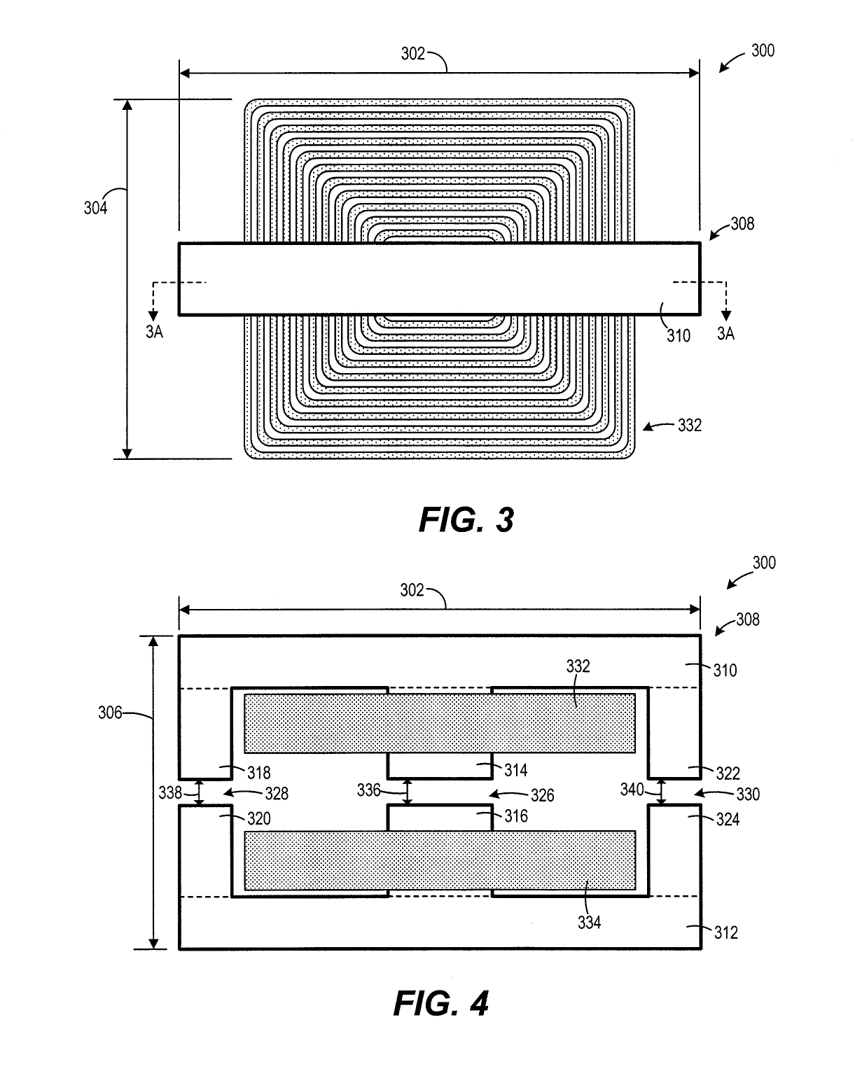

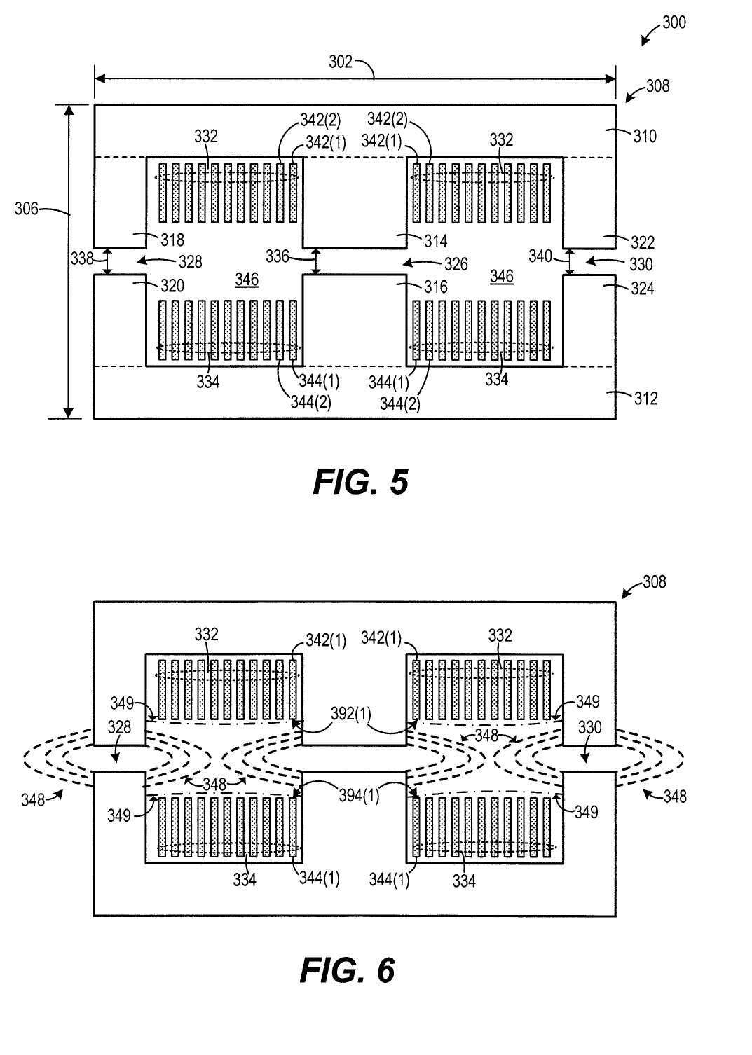

FIG. 3 is a top plan view, and FIG. 4 is a side elevational view, of a magnetic device 300, which is one embodiment of a magnetic device including foil windings disposed substantially outside of gap-induced, fringing magnetic flux paths. FIG. 5 is a vertical cross-sectional view of magnetic device 300 taken along line 3A-3A of FIG. 3. Magnetic device 300 has a length 302, a width 304, and a height 306.

Magnetic device 300 includes a magnetic core 308 including end pieces 310 and 312, inner posts 314 and 316, and outer elements 318, 320, 322, and 324. Although FIGS. 4 and 5 include dashed lines delineating various components of magnetic core 308 to help a viewer distinguish these components, it should be understood that the dashed lines do not necessarily represent discontinuities in magnetic core 308.

End pieces 310 and 312 are offset from each other in the height 306 direction. Inner posts 314 and 316 are collinear and are separated from each other in the height 306 direction by an inner gap 326, such that inner posts 314 and 316 and inner gap 326 collectively join end pieces 310 and 312 in the height 306 direction. Outer elements 318 and 320 are collinear and are separated from each other in the height 306 direction by an outer gap 328, such that outer elements 318 and 320 and outer gap 328 collectively join end pieces 310 and 312 in the height 306 direction. Similarly, outer elements 322 and 324 are collinear and are separated from each other in the height 306 direction by an outer gap 330, such that outer elements 322 and 324 and outer gap 330 collectively join end pieces 310 and 312 in the height 306 direction. Outer elements 318 and 322 and inner post 314 are offset from each other in the lengthwise 302 direction, and outer elements 320 and 324 and inner post 316 are offset from each other in the lengthwise 302 direction. Accordingly, in some embodiments, magnetic core 308 is formed from two E-shaped magnetic elements separated from each other by inner gap 326 and outer gaps 328 and 330. Inner gap 326 and outer gaps 328 and 330 are each filled with a material, such as air, plastic, paper, and/or glue, having a lower magnetic permeability than the one or more magnetic materials forming magnetic core 308. Inner gap 326 and outer gaps 328 and 330 are used, for example, to prevent magnetic saturation of magnetic device 300 and/or to achieve desired energy storage. Additionally, as will be explained below, the positioning of the gaps relative to the foil windings helps equalize the current flow in the edges of the foil.

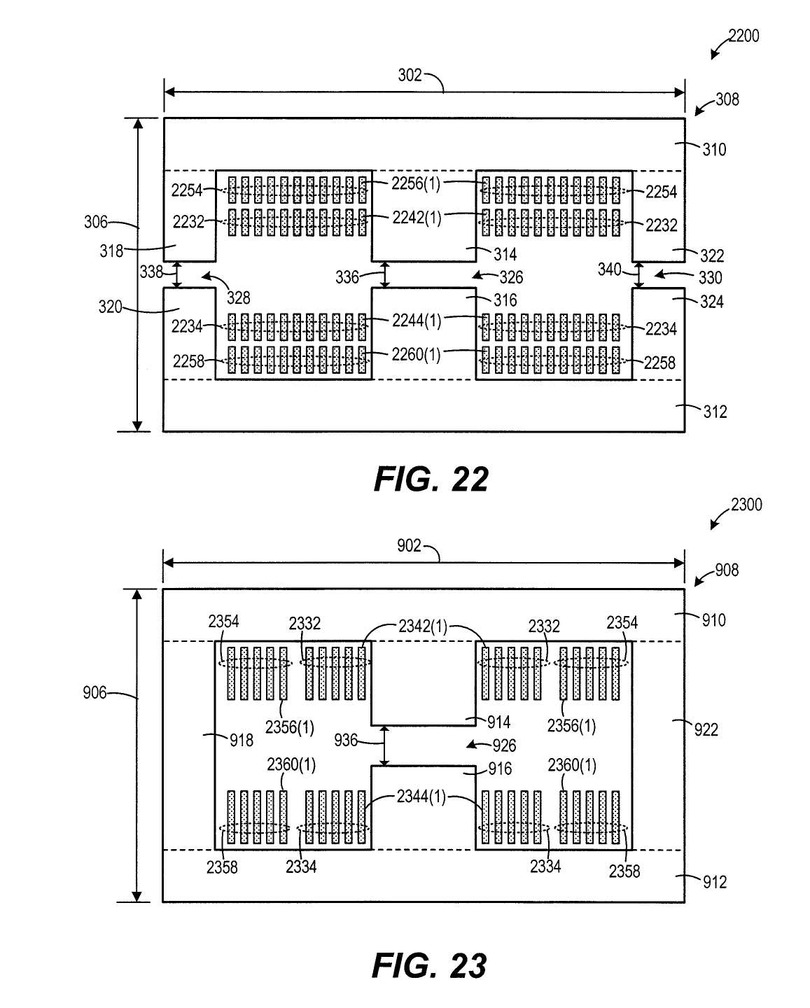

Magnetic device 300 further includes foil windings 332 and 334. In some embodiments, foil winding 332 is electrically coupled to foil winding 334 in series or in parallel, such that magnetic device 300 can be used as an inductor. In some other embodiments, foil winding 332 is at least partially electrically isolated from foil winding 334, such that magnetic device 300 can be used as a transformer. Some other embodiments that may be particularly well suited from transformer applications are discussed below with respect to FIGS. 22 and 23. Foil winding 332 is wound around inner post 314 without extending along a respective height 336, 338, and 340 of inner gap 326, outer gap 328, and outer gap 330, respectively. Similarly, foil winding 334 is wound around inner post 316 without extending along a respective height 336, 338, and 340 of inner gap 326, outer gap 328, and outer gap 330, respectively. Foil winding 332 forms a plurality of winding turns 342, and foil winding 334 forms a plurality of winding turns 344 (see FIG. 5). In this document, specific instances of an item may be referred to by use of a numeral in parentheses (e.g., winding turn 342(1)) while numerals without parentheses refer to any such item (e.g., winding turns 342). Only some instances of winding turns 342 and 344 are labeled in FIG. 5 for illustrative clarity. In some embodiments, volume 346 between foil windings 332 and 334 in the height 306 direction is filled with a dielectric material (not shown).

The fact that foil windings 332 and 334 are wound around respective inner posts without extending along gap heights 336, 338, and 340 advantageously causes the foil windings to be substantially disposed outside of gap-induced, fringing magnetic flux paths. Consider, for example, FIG. 6, which is a cross-sectional view like that of FIG. 5, illustrating approximate fringing magnetic flux paths of magnetic device 300. As illustrated, fringing magnetic flux 348 is emitted from each of inner gap 326, outer gap 328, and outer gap 330. However, the fact that foil windings 332 and 334 are wound around respective inner posts without extending along gap heights 336, 338, and 340 causes foil windings 332 and 334 to be disposed substantially outside of gap-induced, fringing magnetic flux 348 paths, as illustrated. Thus, foil windings 332 and 334 are outside the region of the highest gap-induced, fringing magnetic flux 348, and therefore, certain embodiments of magnetic device 300 are capable of achieving low AC winding resistance.

Additionally, magnetic flux 349 near inner edges 392 and 394 of foil windings 332 and 334, respectively, flows in substantially straight lines extending in the lengthwise 302 direction, as illustrated in FIG. 6. Therefore, magnetic flux 349 in the vicinity of inner edges 392 and 394 is substantially parallel to surfaces defined by the inner edges. Additionally, magnetic field strength is approximately constant along the path of magnetic flux 349. These uniform, parallel magnetic fields in the vicinity of inner edges 392 and 394 promote equal AC current magnitude among inner edges 392 and among inner edges 394, thereby further helping achieve low AC winding resistance in magnetic device 300. Only some instances of inner edges 392 and 394 are labeled in FIG. 6 to promote illustrative clarity.

Additionally, it should be appreciated that magnetic device 300 is potentially relatively simple to construct. For example, foil winding 332 and 334 can be formed by winding a rectangular piece of foil around respective inner posts, with appropriate insulation between winding turns. It is not necessary for foil windings 332 and 334 to have complex shapes or be wound to achieve cavities. Accordingly, certain embodiments of magnetic device 300 achieve low foil AC winding resistance comparable to that obtainable using techniques disclosed in Sullivan '317, without the potential manufacturing difficulties associated with forming windings cavities adjacent to gaps.

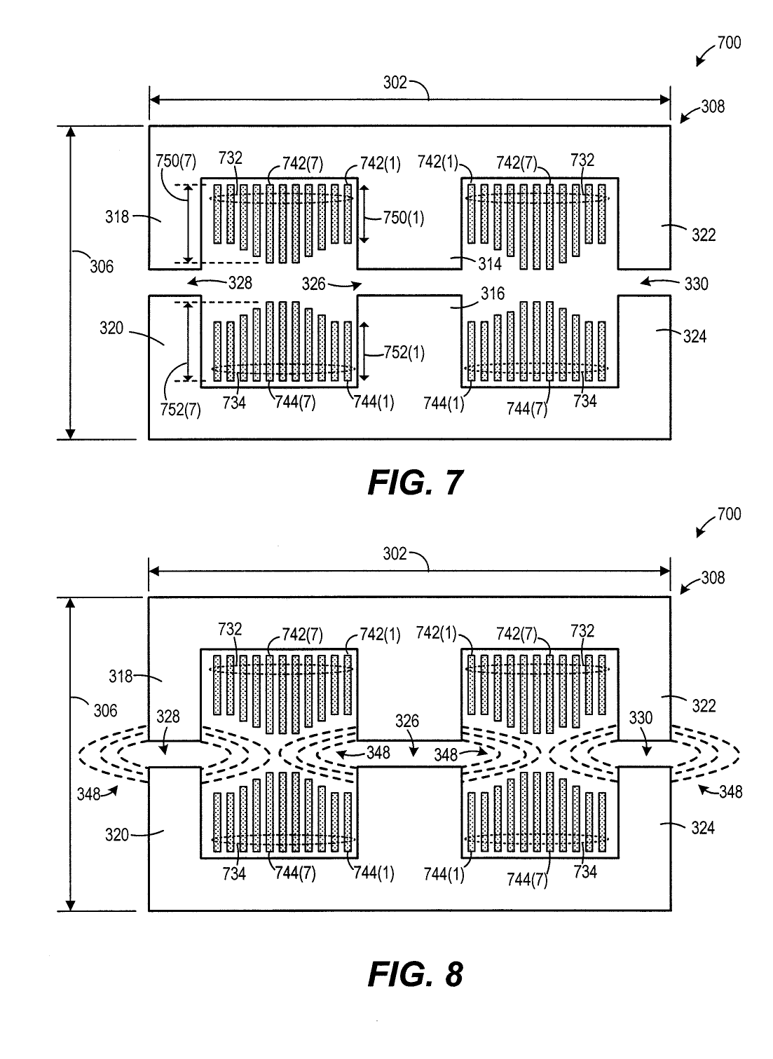

A reduction in winding DC resistance can be optionally achieved, with the possible tradeoff of increased manufacturing complexity, by increasing height of winding turns located away from inner gap 326 and outer gaps 328 and 330. Increasing winding turn height increases winding cross-sectional area, thereby reducing winding DC resistance, because DC current flows substantively through the entire winding cross-sectional area. For example, FIG. 7 is a vertical cross-sectional view of a magnetic device 700, which is similar to magnetic device 300 of FIGS. 3-6, but where some foil winding turns have increased heights, to reduce winding DC resistance.

In particular, magnetic device 700 includes foil windings 732 and 734 in place of foil windings 332 and 334, respectively. Foil winding 732 forms multiple winding turns 742 having respective heights 750, and foil winding 734 forms multiple winding turns 744 having respective heights 752. For example, winding turn 742(1) has height 750(1) and winding turn 742(7) has height 750(7). Only some instances of winding turns 742 and 744, and associated winding heights 750 and 752, are labeled for illustrative clarity.

Instances of winding turn 742 located approximately midway between inner post 314 and outer element 318, as well as instances located approximately midway between inner post 314 and outer element 322, have the largest respective height 750 values. Conversely, winding turn 742 instances located proximate to inner post 314, outer element 318, or outer element 322 have the smallest respective height 750 values. Similarly, winding turn 744 instances located approximately midway between inner post 316 and outer element 320, as well as instances located approximately midway between inner post 316 and outer element 324, have the largest respective height 752 values. Winding turn 744 instances located proximate to inner post 316, outer element 320, or outer element 324 have the smallest respective height 752 values. This distribution of winding turn heights helps minimize both DC resistance and AC resistance of foil windings 732 and 734.

FIG. 8 is a cross-sectional view like that of FIG. 7, illustrating approximate fringing magnetic flux paths of magnetic device 700. As illustrated, foil windings 732 and 734 are substantially outside of fringing magnetic flux 348 paths, similar to foil windings 332 and 334 of magnetic device 300, thereby promoting low winding AC resistance. Additionally, the surface defined by the edges of winding turns 742 and 744 follows the contour of fringing magnetic flux paths 348, promoting equal current in the edges of winding turns 742 and 744. Furthermore, the relatively large heights of certain winding turn 742 and 744 instances promote low winding DC resistance. Accordingly, magnetic device 700 may have achieve lower DC winding resistance than magnetic device 300, assuming otherwise similar configurations.

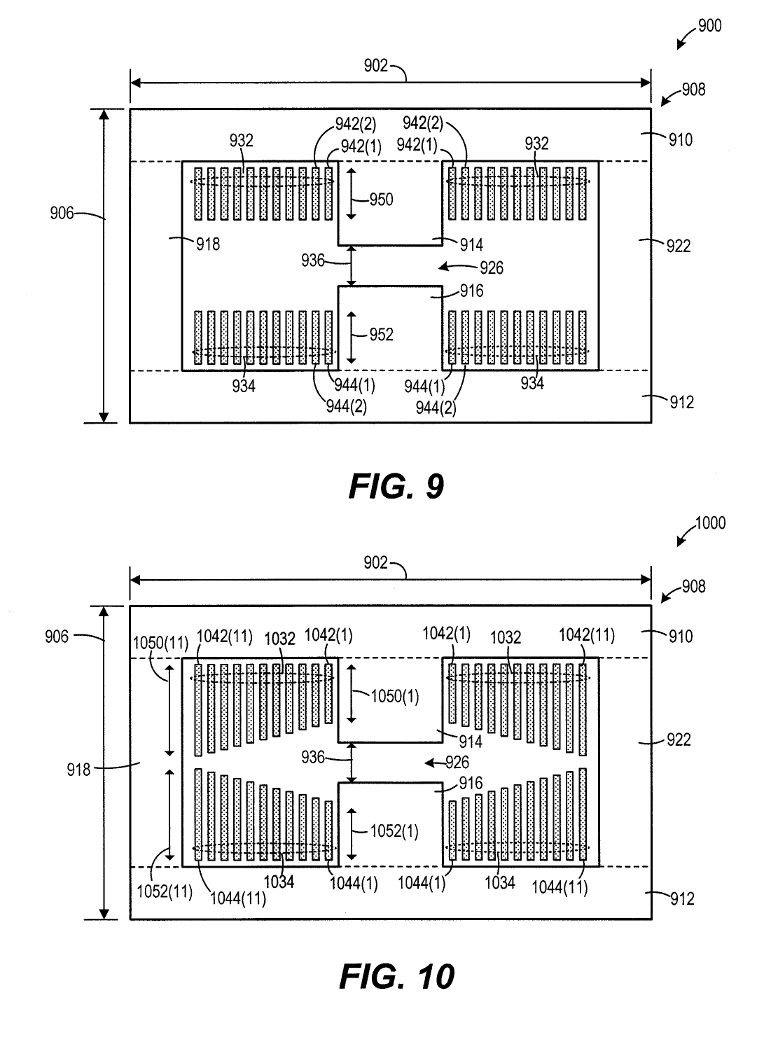

Magnetic device 300 could be modified so that magnetic core 308 does not form outer gaps, to simplify magnetic device construction and/or to reduce the likelihood fringing magnetic flux affecting nearby components. For example, FIG. 9 is a vertical cross-sectional view of a magnetic device 900, which is similar to magnetic device 300 of FIGS. 3-6, but where the magnetic core does not form outer gaps. Magnetic device 900 has a length 902 and a height 906, as well as a width (not shown) orthogonal to length 902 and height 906. Magnetic device 900 includes a magnetic core 908 including end pieces 910 and 912, inner posts 914 and 916, and outer elements 918 and 922. Inner posts 914 and 916 are collinear and are separated from each other in the height 906 direction by an inner gap 926, such that inner posts 914 and 916 and inner gap 926 collectively join end pieces 910 and 912 in the height 906 direction. Outer elements 918 and 922 each join end pieces 910 and 912 in the height 906 direction. Accordingly, in some embodiments, magnetic core 908 is formed of two E-shaped cores with a gap between center legs. Although FIG. 9 includes dashed lines delineating various components of magnetic core 908 to help a viewer distinguish these components, it should be understood that the dashed lines do not necessarily represent discontinuities in magnetic core 908.

Magnetic device 900 further includes foil windings 932 and 934. Foil winding 932 is wound around inner post 914 without extending along a height 936 of inner gap 926, and foil winding 934 is wound around inner post 916 without extending along height 936 of inner gap 926. This configuration of foil windings 932 and 934 advantageously helps minimize effect of fringing magnetic flux on the foil windings, in a manner similar to that of magnetic device 300. Foil winding 932 forms a plurality of winding turns 942 having winding turn height 950, and foil winding 934 forms a plurality of winding turns 944 having winding turn height 952. Only some winding turn 942 and 944 instances are labeled for illustrative clarity.

Height 936 of inner gap 926 may need to be relatively large to compensate for lack of outer gaps in magnetic core 908. Such large value of gap height 936 increases size of fringing magnetic flux paths, necessitating height 950 of winding turns 942, and height 952 of windings turns 944 to be smaller than corresponding winding turn heights of magnetic device 300. Smaller winding turn height reduces winding cross-sectional area available to conduct current, and magnetic device 900 may therefore have larger winding DC resistance than magnetic device 300, assuming all else is equal.

Accordingly, Applicants have developed a single-gap magnetic device with unequal winding heights, which at least partially overcomes the relatively large winding DC resistance of magnetic device 900. FIG. 10 is a vertical cross-sectional view of a magnetic device 1000, which is similar to magnetic device 900 of FIG. 9, but with foil windings 1032 and 1034 replacing foil windings 932 and 934, respectively. Foil winding 1032 is separated from foil winding 1034 in the height 906 direction. Foil winding 1032 includes a plurality of winding turns 1042 having respective winding heights 1050, and foil winding 1034 includes a plurality of winding turns 1044 having respective heights 1052. For example, winding turn 1042(1) has winding height 1050(1), and winding turn 1044(11) has winding height 1052(11). Only some instances of winding turns 1042 and 1044, as well as winding heights 1050 and 1052, are labeled for illustrative clarity.

Values of winding turn heights 1050 increase with increasing lengthwise 902 distance from inner post 914, and values of winding turn heights 1052 increase with increasing lengthwise 902 distance from inner post 916. Thus, winding turn 1042 instances furthest from inner post 914 have largest winding turn height 1050 values, and winding turn 1044 instances furthest from inner post 916 have largest winding turn height 1052 values. Such configuration helps decrease winding DC resistance, while keeping foil windings 1032 and 1034 substantially outside of fringing magnetic flux paths, in a manner similar to that discussed above with respect to FIGS. 7 and 8. Thus, magnetic device 1000 may have lower winding DC resistance than magnetic device 900, assuming otherwise similar construction.

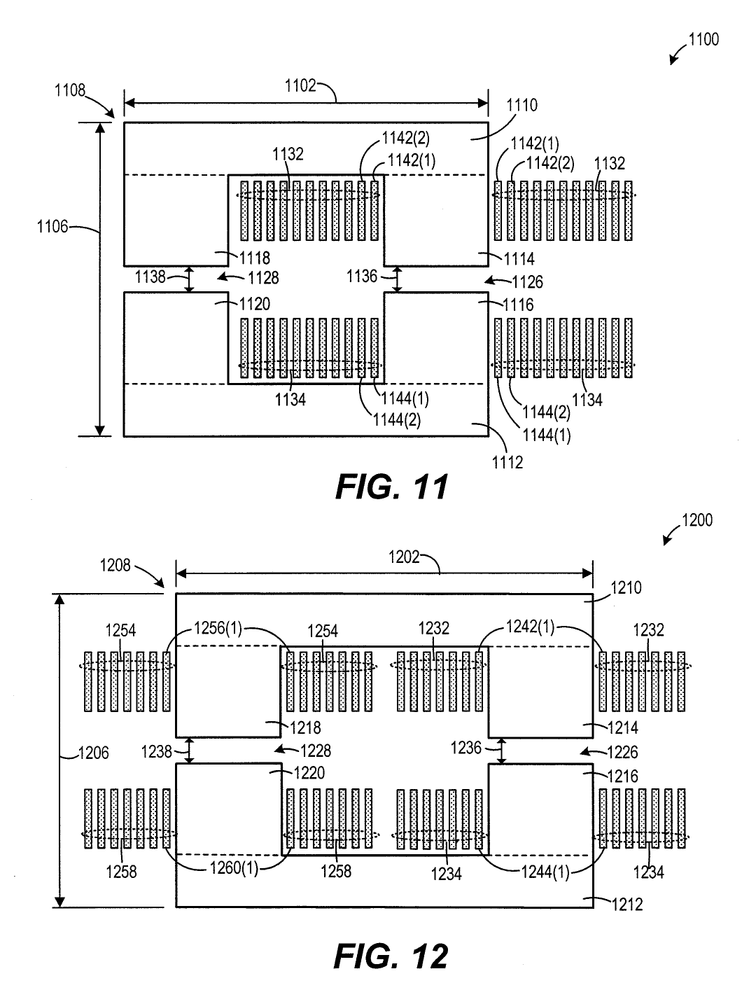

FIG. 11 is a vertical cross-sectional view of a magnetic device 1100, which is similar to magnetic device 300 of FIGS. 3-6, but where the magnetic core includes only two outer elements. Magnetic device 1100 has a length 1102 and a height 1106, as well as a width (not shown) orthogonal to length 1102 and height 1106. Magnetic device 1100 includes a magnetic core 1108 including end pieces 1110 and 1112, inner posts 1114 and 1116, and outer elements 1118 and 1120. Inner posts 1114 and 1116 are collinear and are separated from each other in the height 1106 direction by an inner gap 1126, such that inner posts 1114 and 1116 and inner gap 1126 collectively join end pieces 1110 and 1112 in the height 1106 direction. Outer elements 1118 and 1120 are collinear and are separated from each other in the height 1106 direction by an outer gap 1128, such that outer elements 1118 and 1120 and outer gap 1128 collectively join end pieces 1110 and 1112 in the height 1106 direction. Accordingly, in some embodiments, magnetic core 1108 is formed from two U-shaped magnetic elements separated from each other by inner gap 1126 and outer gap 1128. Although FIG. 11 includes dashed lines delineating various components of magnetic core 1108 to help a viewer distinguish these components, it should be understood that the dashed lines do not necessarily represent discontinuities in magnetic core 1108. Additionally, although the terms “inner posts” and “outer elements” are used in the discussion of FIG. 11 for consistency with embodiments discussed above, in some embodiments, magnetic core 1108 is symmetric, such that the inner posts and the outer elements are interchangeable.

Magnetic device 1100 further includes foil windings 1132 and 1134. Foil winding 1132 is wound around inner post 1114 without extending along a height 1136 of inner gap 1126 and without extending along a height 1138 of outer gap 1128. Foil winding 1134 is wound around inner post 1116 without extending along height 1136 of inner gap 1126 and without extending along height 1138 of outer gap 1128. Accordingly, magnetic device 1100 achieves low winding AC resistance in a manner similar to that of magnetic device 300. Foil winding 1132 includes a plurality of winding turns 1142, and foil winding 1134 includes a plurality of winding turns 1144.

The magnetic devices discussed above could be modified to include additional windings and/or gaps, as long as windings do not extend along gap heights. For example, FIG. 12 is a vertical cross-sectional view of a magnetic device 1200, which is similar to magnetic device 1100, but includes additional foil windings.

Magnetic device 1200 has a length 1202 and a height 1206, as well as a width (not shown) orthogonal to length 1202 and height 1206. Magnetic device 1200 includes a magnetic core 1208 including end pieces 1210 and 1212, inner posts 1214 and 1216, and outer elements 1218 and 1220. Inner posts 1214 and 1216 are collinear and are separated from each other in the height 1206 direction by an inner gap 1226, such that inner posts 1214 and 1216 and inner gap 1226 collectively join end pieces 1210 and 1212 in the height 1206 direction. Outer elements 1218 and 1220 are collinear and are separated from each other in the height 1206 direction by an outer gap 1228, such that outer elements 1218 and 1220 and outer gap 1228 collectively join end pieces 1210 and 1212 in the height 1206 direction. Accordingly, in some embodiments, magnetic core 1208 is formed from two U-shaped magnetic elements separated from each other by inner gap 1226 and outer gap 1228. Although FIG. 12 includes dashed lines delineating various components of magnetic core 1208 to help a viewer distinguish these components, it should be understood that the dashed lines do not necessarily represent discontinuities in magnetic core 1208. Additionally, although the terms “inner posts” and “outer elements” are used in the discussion of FIG. 12 for consistency with embodiments discussed above, in some embodiments, magnetic core 1208 is symmetric, such that the inner posts and the outer elements are interchangeable.

Magnetic device 1200 further includes four foil windings 1232, 1234, 1254, and 1258. Foil windings 1232 and 1234 are wound around inner posts 1214 and 1216, respectively, without extending along a height 1236 of inner gap 1226 and without extending along a height 1238 of outer gap 1228. Foil windings 1254 and 1258 are wound around outer elements 1218 and 1220, respectively, without extending along height 1236 of inner gap 1226 and without extending along height 1238 of outer gap 1228. Accordingly, magnetic device 1200 achieves low winding AC resistance in a manner similar to that of magnetic device 300, but with four foil windings instead of two foil windings. Foil windings 1232, 1234, 1254, and 1258 form winding turns 1242, 1244, 1256, and 1260, respectively. Only some winding turn instances are labeled for illustrative clarity.

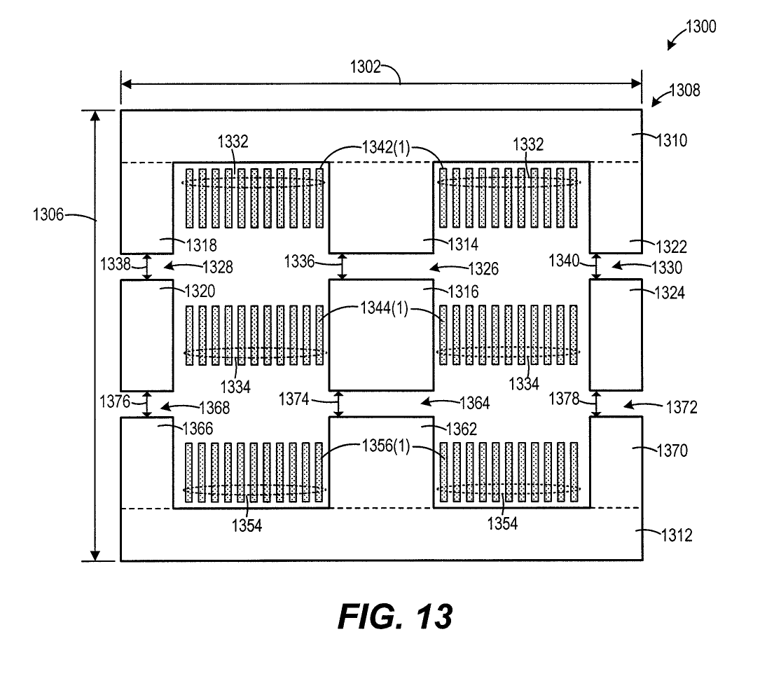

FIG. 13 is a vertical cross-sectional view of a magnetic device 1300, which is similar to magnetic device 300, but includes additional foil windings and additional gaps in the magnetic core. Magnetic device 1300 has a length 1302 and a height 1306, as well as a width (not shown) orthogonal to length 1302 and height 1306.

Magnetic device 1300 includes a magnetic core 1308 including end pieces 1310 and 1312, inner posts 1314, 1316, and 1362, and outer elements 1318, 1320, 1322, 1324, 1366, and 1370. Although FIG. 13 includes dashed lines delineating various components of magnetic core 1308 to help a viewer distinguish these components, it should be understood that the dashed lines do not necessarily represent discontinuities in magnetic core 1308.

End pieces 1310 and 1312 are offset from each other in the height 1306 direction. Inner posts 1314, 1316, and 1362 are collinear. Inner posts 1314 and 1316 are separated from each other in the height 1306 direction by an inner gap 1326, and inner posts 1316 and 1362 are separated from each other in the height 1306 direction by an inner gap 1364. Inner posts 1314, 1316, and 1362 and inner gaps 1326 and 1364 collectively join end pieces 1310 and 1312 in the height 1306 direction.

Outer elements 1318, 1320, and 1366 are collinear. Outer elements 1318 and 1320 are separated from each other in the height 1306 direction by an outer gap 1328, and outer element 1320 and 1366 are separated from each other in the height 1306 direction by an outer gap 1368. Outer elements 1318, 1320, and 1366 and outer gaps 1328 and 1368 collectively join end pieces 1310 and 1312 in the height 1306 direction.

Outer elements 1322, 1324, and 1370 are collinear. Outer elements 1322 and 1324 are separated from each other in the height 1306 direction by an outer gap 1330, and outer element 1324 and 1370 are separated from each other in the height 1306 direction by an outer gap 1372. Outer elements 1322, 1324, and 1370 and outer gaps 1330 and 1372 collectively join end pieces 1310 and 1312 in the height 1306 direction.

Magnetic device 1300 further includes foil windings 1332, 1334, and 1354. Foil winding 1332 is wound around inner post 1314, foil winding 1334 is wound around inner post 1316, and foil winding 1354 is wound around inner post 1362. Foil windings 1332, 1334, and 1354 are each wound around their respective inner posts without extending along heights 1336 1374 of inner gaps 1326 and 1364, respectively. Additionally, foil windings 1332, 1334, and 1354 are each wound around their respective inner posts without extending along heights 1338, 1340, 1376, and 1378 of outer gaps 1328, 1330, 1368, and 1372, respectively. Accordingly, magnetic device 1300 achieves low winding AC resistance in a manner similar to that of magnetic device 300, but with additional windings and gaps. Foil windings 1332, 1334, and 1354 form winding turns 1342, 1344, and 1356, respectively. Only some winding turn instances are labeled for illustrative clarity.

FIG. 22 is a vertical cross-sectional view of a magnetic device 2200, which is similar to magnetic device 300 of FIGS. 3-6, but includes four windings. In particular, magnetic device 2200 includes foil windings 2232 and 2234 in place of foil windings 332 and 334, respectively. Additionally, magnetic device 2200 further includes foil windings 2254 and 2258. Foil windings 2232 and 2254 are each wound around inner post 314 without extending along a respective height 336, 338, and 340 of inner gap 326, outer gap 328, and outer gap 330. Foil windings 2234 and 2258 are each wound around inner post 316 without extending along a respective height 336, 338, and 340 of inner gap 326, outer gap 328, and outer gap 330. This configuration of the foil windings advantageously helps minimize effect of fringing magnetic flux on the foil windings, in a manner similar to that of magnetic device 300. Foil windings 2232, 2234, 2254, and 2258 form multiple winding turns 2242, 2244, 2256, and 2260, respectively. Only some instances of winding turns 2242, 2244, 2256, and 2260 are labeled for illustrative clarity.

While not required, it is anticipated that magnetic device 2200 will be used as a transformer. Efficient operation is promoted in typical transformer applications if (1) foil windings 2232 and 2234 collectively serve as a primary winding of the transformer, and (2) foil windings 2254 and 2258 collectively serve as a secondary winding of the transformer. Such configuration causes the primary winding to be closest to gaps 326, 328, and 330, thereby helping minimize flow of magnetizing inductance magnetic flux across the secondary winding. Magnetizing inductance is primarily achieved by energy storage in gaps 326, 328, and 330, and magnetizing inductance can therefore be varied during the design of magnetic device 300 by varying the configuration of the gaps. A particular magnetizing inductance may be desired, for example, to prevent saturation of magnetic core 308 when the windings are carry DC current or to achieve a particular resonant frequency in resonant converter applications. In some alternate embodiments, outer gaps 328 and 330 are omitted, such that magnetic device 300 has a magnetic core similar to that of FIGS. 9 and 10.

FIG. 23 is a vertical cross-sectional view of a magnetic device 2300, which is similar to magnetic device 900 of FIG. 9 but includes four windings. In particular, magnetic device 2300 includes foil windings 2332 and 2334 in place of foil windings 932 and 934, respectively. Additionally, magnetic device 2300 further includes foil windings 2354 and 2358. Foil windings 2332 and 2354 are each wound around inner post 914 without extending along height 936 of inner gap 926. Foil windings 2334 and 2358 are each wound around inner post 916 without extending along height 936 of inner gap 926. This configuration of the foil windings advantageously helps minimize effect of fringing magnetic flux on the foil windings, in a manner similar to that of magnetic device 300. Foil winding 2354 is wound around foil winding 2332 such that foil windings 2332 and 2354 are concentric, and foil winding 2358 is wound around foil winding 2334 such that foil windings 2334 and 2358 are concentric. Foil windings 2332, 2334, 2354, and 2358 form multiple winding turns 2342, 2344, 2356, and 2360, respectively. Only some instances of winding turns 2342, 2344, 2356, and 2360 are labeled for illustrative clarity.

It is also anticipated that magnetic device 2300 will typically be used as a transformer, although magnetic device 2300 is not limited to transformer applications. For example, foil windings 2332 and 2334 may collectively serve as a primary winding of a transformer, and foil windings 2354 and 2358 may collectively serve as a secondary winding of the transformer. This configuration causes the primary winding to be closest to gap 926, thereby helping minimize flow of magnetizing inductance magnetic flux across the secondary winding. Magnetic flux associated with energy transfer between windings will flow through the windings at least partially in the height 906 direction. Therefore, in some embodiments, foil windings 2332, 2334, 2354, and 2358 are thin to minimize circulating eddy currents, and associated AC resistance, in the windings.

FIG. 23 illustrates significant space between foil winding 2332 and 2354, as well as between foil windings 2334 and 2358, to help a viewer distinguish the windings. In many applications, however, there will be minimal spacing between adjacent foil windings to minimize magnetic device size and leakage inductance. In some alternate embodiments, outer elements 918 and 922 are modified to form gaps in the height direction, such that magnetic device 2300 has a magnetic core similar to that of FIG. 22.

### Magnetic Devices Including a Single Winding

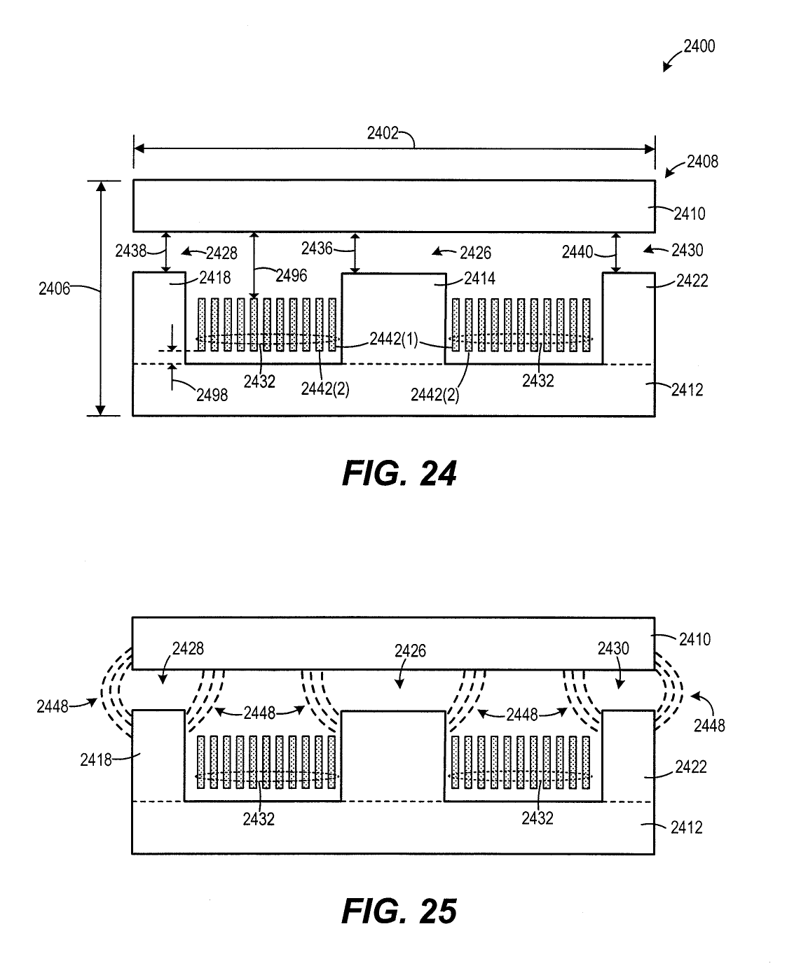

Applicants have also discovered that low AC resistance can be achieved in a magnetic device including a gapped magnetic core and a single foil winding by appropriate placement of the foil winding relative to magnetic core gaps. For example, FIG. 24 is a vertical cross-sectional view of a magnetic device 2400 including a single foil winding. Magnetic device 2400 has a length 2402 and a height 2406, as well as a width (not shown) orthogonal to length 2402 and height 2406. Magnetic device 2400 includes a magnetic core 2408 including end pieces 2410 and 2412, inner post 2414, and outer elements 2418 and 2422. Inner post 2414 is separated from end piece 2410 by an inner gap 2426. Outer elements 2418 and 2422 are separated from end piece 2410 by outer gaps 2428 and 2430, respectively. Accordingly, in some embodiments, magnetic core 2408 is formed of an E-shaped core and an I-shaped core. Although FIG. 24 includes dashed lines delineating various components of magnetic core 2408 to help a viewer distinguish these components, it should be understood that the dashed lines do not necessarily represent discontinuities in magnetic core 2408.

Magnetic device 2400 further includes a foil winding 2432 wound around inner post 2414. Foil winding 2432 forms multiple winding turns 2442. Only some instances of winding turns 2442 are labeled in FIG. 24 to promote illustrative clarity. Foil winding 2432 is separated from end piece 2410 by a separation distance 2496 in the height 2406 direction, and foil winding 2432 is separated from end piece 2412 by a separation distance 2498 in the height 2406 direction. Separation distance 2496 is greater than separation distance 2498 so that foil winding 2432 does not extend along a height 2436, 2438, and 2440 of inner gap 2426, outer gap 2428, and outer gap 2430, respectively. This configuration of foil winding 2432 relative to gaps 2426, 2428, and 2430 advantageously helps minimize effect of fringing magnetic flux on the foil winding.

Consider, for example, FIG. 25, which is a cross-sectional view like that of FIG. 24, illustrating approximate fringing magnetic flux paths of magnetic device 2400. As illustrated, fringing magnetic flux 2448 is emitted from each of inner gap 2426, outer gap 2428, and outer gap 2430. However, the fact that separation distance 2496 is greater than separation distance 2498 causes foil winding 2432 to be disposed substantially outside of gap-induced, fringing magnetic flux 2448 paths, as illustrated. Thus, foil winding 2432 is outside the region of the highest gap-induced, fringing magnetic flux 2448, and therefore, certain embodiments of magnetic device 2400 are capable of achieving low AC winding resistance.

Variations of magnetic device 2400 are possible. For example, one or more of gaps 2426, 2428, and 2430 could be omitted with departing from the scope hereof. As another example, windings could be wound around one or more of outer elements 2418 and 2422, in place of, or in addition to, foil winding 2432, as long as separation distance 2496 between each winding and end piece 2410 is greater than separation distance 2498 between each winding and end piece 2412. Furthermore, one of outer elements 2418 and 2422 could be omitted without departing from scope hereof.

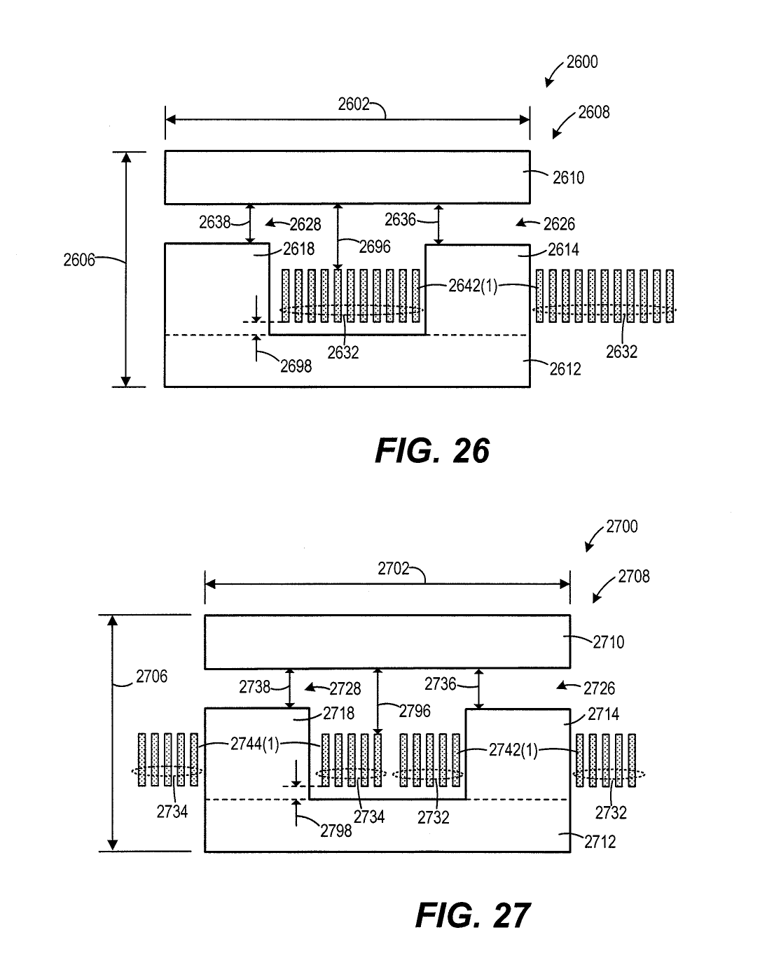

For example, FIG. 26 is a vertical cross-sectional view of a magnetic device 2600, which is similar to magnetic device 2400 of FIGS. 24 and 25, but with a magnetic core including only a single outer element. Magnetic device 2600 has a length 2602 and a height 2606, as well as a width (not shown) orthogonal to length 2602 and height 2606. Magnetic device 2600 includes a magnetic core 2608 including end pieces 2610 and 2612, inner post 2614, and outer element 2618. Inner post 2614 is separated from end piece 2610 by an inner gap 2626. Outer element 2618 is separated from end piece 2610 by outer gap 2628. Accordingly, in some embodiments, magnetic core 2608 is formed of a U-shaped core and an I-shaped core. Although FIG. 26 includes dashed lines delineating various components of magnetic core 2608 to help a viewer distinguish these components, it should be understood that the dashed lines do not necessarily represent discontinuities in magnetic core 2608. Additionally, although the terms “inner post” and “outer element” are used in the discussion of FIG. 26 for consistency with magnetic device 2400 of FIGS. 24 and 25, in some embodiments, magnetic core 2608 is symmetric, such that inner post 2614 and the outer element 2618 are interchangeable.

Magnetic device 2600 further includes foil winding 2632 wound around inner post 2614. Foil winding 2632 forms multiple winding turns 2642. Only some instances of winding turns 2642 are labeled in FIG. 26 to promote illustrative clarity. Foil winding 2632 is separated from end piece 2610 by a separation distance 2696 in the height 2606 direction, and foil winding 2632 is separated from end piece 2612 by a separation distance 2698 in the height 2606 direction. Separation distance 2696 is greater than separation distance 2698 so that foil winding 2632 does not extend along a height 2636 and 2638 of inner gap 2626 and outer gap 2628, respectively. This configuration of foil winding 2632 relative to gaps 2626 and 2628 advantageously helps minimize effect of fringing magnetic flux on the foil winding in a manner similar to that discussed above with respect to magnetic device 2400 of FIGS. 24 and 25.

As another example, FIG. 27 is a vertical cross-sectional view of a magnetic device 2700, which is similar to magnetic device 2600 of FIG. 26, but includes two windings. Magnetic device 2700 has a length 2702 and a height 2706, as well as a width (not shown) orthogonal to length 2702 and height 2706. Magnetic device 2700 includes a magnetic core 2708 including end pieces 2710 and 2712, inner post 2714, and outer element 2718. Inner post 2714 is separated from end piece 2710 by an inner gap 2726. Outer element 2718 is separated from end piece 2710 by outer gap 2728. Accordingly, in some embodiments, magnetic core 2708 is formed of a U-shaped core and an I-shaped core. Although FIG. 27 includes dashed lines delineating various components of magnetic core 2708 to help a viewer distinguish these components, it should be understood that the dashed lines do not necessarily represent discontinuities in magnetic core 2708.

Magnetic device 2700 further includes a foil winding 2732 wound around inner post 2714 and a foil winding 2734 wound around outer element 2718. Foil winding 2732 forms multiple winding turns 2742, and foil winding 2734 forms multiple winding turns 2744. Only some instances of winding turns 2742 and 2744 are labeled in FIG. 27 to promote illustrative clarity. Foil windings 2732 and 2734 are separated from end piece 2710 by a separation distance 2796 in the height 2706 direction, and foil windings 2732 and 2734 are each separated from end piece 2712 by a separation distance 2798 in the height 2706 direction. Separation distance 2796 is greater than separation distance 2798 so that foil windings 2732 and 2734 do not extend along a height 2736 and 2738 of inner gap 2726 and outer gap 2728, respectively. This configuration of foil windings 2732 and 2734 relative to gaps 2726 and 2728 advantageously helps minimize effect of fringing magnetic flux on the foil winding in a manner similar to that discussed above with respect to magnetic device 2400 of FIGS. 24 and 25. Additionally, although the terms “inner post” and “outer element” are used in the discussion of FIG. 27 for consistency with magnetic device 2400 of FIGS. 24 and 25, in some embodiments, magnetic core 2708 is symmetric, such that inner post 2714 and the outer element 2718 are interchangeable.

### Magnetic Devices Including Both Litz Wire and Foil Windings

Litzendraht (litz) wire is constructed from a plurality of insulated wire strands twisted together in a manner that minimizes skin effect. Thus, properly constructed litz wire can be used in place of foil windings, or in place of a single-strand of round cross-sectional wire, to minimize effects of gap-induced, fringing magnetic flux. However, litz wire is relatively expensive, and litz wire may be difficult to connect to external circuitry. Additionally, litz wire has a poor packing factor due to insulation between individual strands and between wires as they are packed together. Furthermore, the insulation and space impedes transfer of heat away from the wire, and litz wire may therefore be more prone to overheat than single-strand wire or foil conductors.

Applicants have developed magnetic devices which take advantage of desirable properties of litz wire while helping minimize its use in the magnetic devices. Such magnetic devices include both litz wire windings and foil windings. Litz wire windings are used within gap-induced, fringing magnetic flux paths, to minimize influence of gap-induced, fringing magnetic flux on winding AC resistance. Foil windings are used in locations outside of gap-induced, fringing magnetic flux paths to promote low cost, high packing factor, and effective winding cooling.

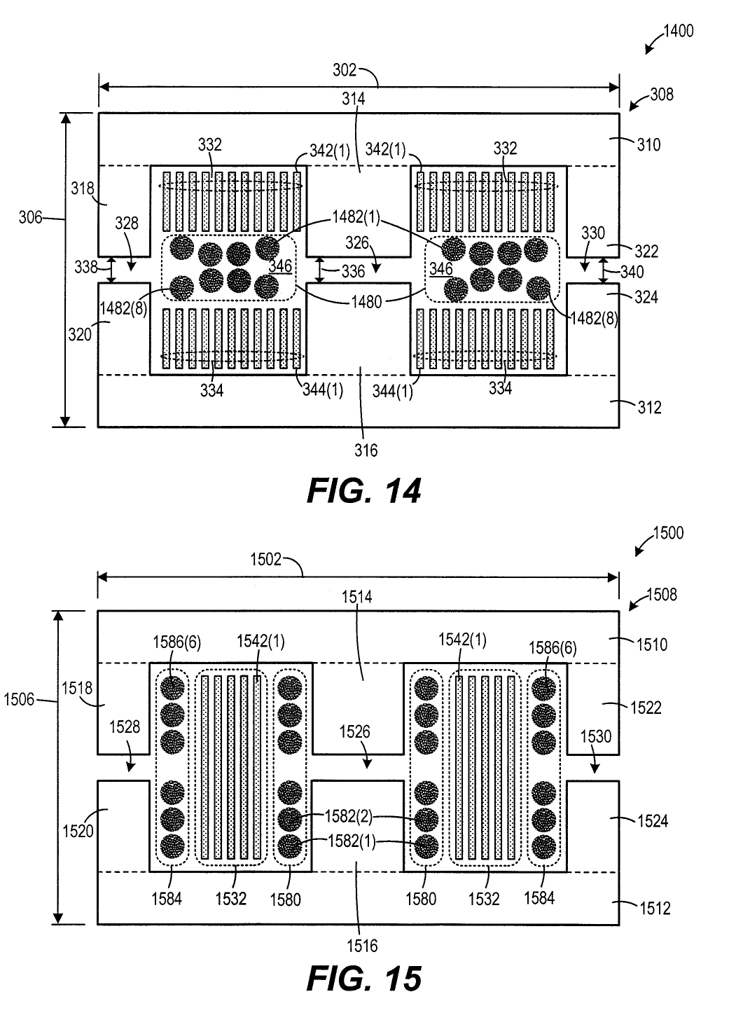

For example, FIG. 14 is a vertical cross-sectional view of a magnetic device 1400, which is similar to magnetic device 300, but further includes a litz wire winding 1480 wound around inner posts 314 and 316 and inner gap 326. Litz wire winding 1480 forms one or more winding turns 1482, only some of which are labeled for illustrative clarity. Litz wire winding 1480 is, for instance, electrically coupled to foil windings 332 and 334. Litz wire winding 1480 is disposed, in the height 306 direction, between foil windings 332 and 334, such that litz wire winding 1480 separates foil windings 332 and 334 in the height 306 direction. Thus, litz wire winding 1480 is disposed in volume 346, adjacent inner gap 336 and outer gaps 328 and 330. As discussed above with respect to FIG. 6, volume 346 is subject to significant gap-induced, fringing magnetic flux. Litz wire winding 1480, however, is relatively immune to the effects of gap-induced, fringing magnetic flux, as discussed above. Therefore, winding AC resistance of magnetic device 1400 is not substantially affected by gap-induced, fringing magnetic flux.

In some embodiments, each of foil winding 332, foil winding 334, and litz wire winding 1480 has the same number of turns, and the windings are electrically coupled in parallel. In these embodiments, AC current flows primarily through litz wire winding 1480, and a substantial portion of DC current flows through foil windings 332 and 334. Due to such current flow and the relative position of the windings, minimal AC magnetic flux flows through foil windings 332 and 334, thereby helping minimize AC losses in foil windings 332 and 334.

FIG. 15 is a vertical cross-sectional view of a magnetic device 1500, which is another magnetic device including both a litz wire winding and a foil winding. Magnetic device 1500 has a length 1502 and a height 1506, as well as a width (not shown) orthogonal to length 1502 and height 1506.

Magnetic device 1500 includes a magnetic core 1508 including end pieces 1510 and 1512, inner posts 1514 and 1516, and outer elements 1518, 1520, 1522, and 1524. Although FIG. 15 includes dashed lines delineating various components of magnetic core 1508 to help a viewer distinguish these components, it should be understood that the dashed lines do not necessarily represent discontinuities in magnetic core 1508. End pieces 1510 and 1512 are offset from each other in the height 1506 direction. Inner posts 1514 and 1516 are collinear and are separated from each other in the height 1506 direction by an inner gap 1526, such that inner posts 1514 and 1516 and inner gap 1526 collectively join end pieces 1510 and 1512 in the height 1506 direction. Outer elements 1518 and 1520 are collinear and are separated from each other in the height 1506 direction by an outer gap 1528, such that outer elements 1518 and 1520 and outer gap 1528 collectively join end pieces 1510 and 1512 in the height 1506 direction. Similarly, outer elements 1522 and 1524 are collinear and are separated from each other in the height 1506 direction by an outer gap 1530, such that outer elements 1522 and 1524 and outer gap 1530 collectively join end pieces 1510 and 1512 in the height 1506 direction. Accordingly, in some embodiments, magnetic core 1508 is formed from two E-shaped magnetic elements separated from each other by inner gap 1526 and outer gaps 1528 and 1530.

Magnetic device 1500 further includes foil winding 1532 and litz wire windings 1580 and 1584. Litz wire winding 1580 is wound around inner posts 1514 and 1516, foil winding 1532 is wound around litz wire winding 1580, and litz wire winding 1584 is wound around foil winding 1532, such that foil winding 1532, litz wire windings 1580 and 1584, and inner posts 1514 and 1516 are concentric. Foil winding 1532 forms a plurality of winding turns 1542, litz wire winding 1580 forms a plurality of winding turns 1582, and litz wire winding 1584 forms a plurality of winding turns 1586. Only some winding turn instances are labeled in FIG. 15 for illustrative clarity. Litz wire is relatively immune to effects of fringing magnetic flux, and therefore, litz wire windings 1580 and 1584 have relatively low AC resistances, even though portions of the windings are located within gap-induced, fringing magnetic flux paths. Foil winding 1532, on the other hand, is significantly separated from inner gap 1526 and outer gaps 1528 and 1530, such that foil winding 1532 is significantly outside of gap-induced, fringing magnetic flux paths. Accordingly, magnetic device 1500 achieves relatively low winding AC resistance.

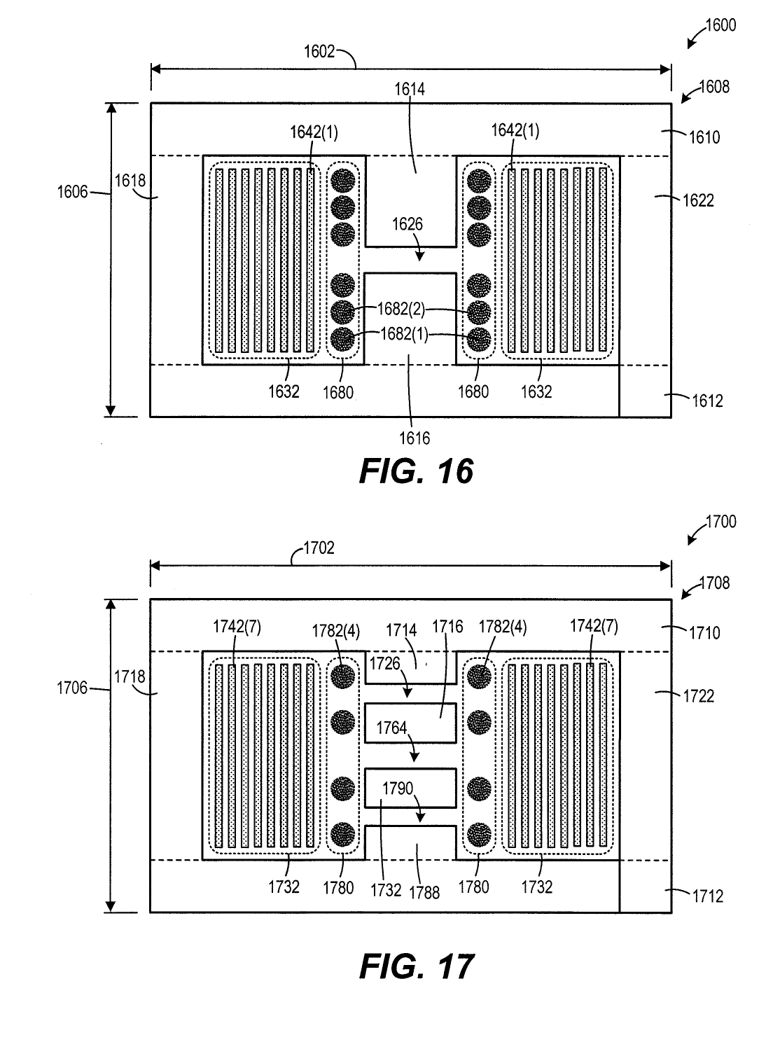

FIG. 16 is a vertical cross-sectional view of a magnetic device 1600, which is similar to magnetic device 1500 of FIG. 15, but where the magnetic core forms only a single gap. Magnetic device 1600 has a length 1602 and a height 1606, as well as a width (not shown) orthogonal to length 1602 and height 1606. Magnetic device 1600 includes a magnetic core 1608 including end pieces 1610 and 1612, inner posts 1614 and 1616, and outer elements 1618 and 1622. Inner posts 1614 and 1616 are collinear and are separated from each other in the height 1606 direction by an inner gap 1626. Outer elements 1618 and 1622 each join end pieces 1610 and 1612 in the height 1606 direction without gaps. Accordingly, in some embodiments, magnetic core 1608 is formed of two E-shaped cores with a gap between center legs.

Magnetic device 1600 further includes foil winding 1632 and litz wire winding 1680. Litz wire winding 1680 is wound around inner posts 1614 and 1616, and foil winding 1632 is wound around litz wire winding 1680, such that foil winding 1632, litz wire winding 1680, and inner posts 1614 and 1616 are concentric. Foil winding 1632 forms a plurality of winding turns 1642, and litz wire winding 1680 forms a plurality of winding turns 1682. Only some winding turn instances are labeled in FIG. 16 for illustrative clarity. Due to lack of gaps in outer elements 1618 and 1622, it is not necessary to separate foil winding 1632 from the outer elements. Accordingly, there is no litz wire winding outside of foil winding 1632 in magnetic device 1600.

The magnetic cores of magnetic devices 1500 and 1600 could be modified to include additional gaps. For example, FIG. 17 is a vertical cross-sectional view of a magnetic device 1700, which is similar to magnetic device 1600 of FIG. 16, but where the magnetic core forms a plurality of inner gaps. Magnetic device 1700 has a length 1702 and a height 1706, as well as a width (not shown) orthogonal to length 1702 and height 1706. Magnetic device 1700 includes a magnetic core 1708 including end pieces 1710 and 1712, inner posts 1714, 1716, 1732, and 1788, and outer elements 1718 and 1722. Inner posts 1714, 1716, 1732, and 1788 are collinear. Inner posts 1714 and 1716 are separated from each other in the height 1706 direction by an inner gap 1726, inner posts 1716 and 1732 are separated from each other in the height 1706 direction by an inner gap 1764, and inner posts 1732 and 1788 are separated from each other in the height 1706 direction by an inner gap 1790. Outer elements 1718 and 1722 each join end pieces 1710 and 1712 in the height 1706 direction without gaps.

Magnetic device 1700 further includes foil winding 1732 and litz wire winding 1780. Litz wire winding 1780 is wound around inner posts 1714, 1716, 1732, and 1788, and foil winding 1732 is wound around litz wire winding 1780, such that foil winding 1732, litz wire winding 1780, and inner posts 1714, 1716, 1732, and 1786 are concentric. Foil winding 1732 forms a plurality of winding turns 1742, and litz wire winding 1780 forms a plurality of winding turns 1782. Only some winding turn instances are labeled in FIG. 17 for illustrative clarity. Although fringing magnetic flux is emitted from each inner of inner gaps 1726, 1764, and 1790, foil winding 1732 is substantially separated from gap-induced, fringing magnetic flux by litz wire winding 1780. Accordingly, magnetic device 1700 achieves relatively low winding AC resistance even though magnetic core 1708 forms multiple inner gaps.

While litz wire is relatively immune to the effects of gap-induced, fringing magnetic flux, as discussed above, there may be benefits to positioning litz wire windings to avoid regions where gap-induced, fringing magnetic flux is the strongest. For example, for a given litz wire strand diameter, positioning litz wire windings in such manner helps minimize proximity effect loss in the litz wire windings. As another example, assuming a given amount of proximity effect loss is tolerable, positioning litz wire windings to avoid the strongest regions of gap-induced, fringing magnetic flux may allow use of larger-diameter, lower-cost litz wire than if litz wire windings were instead uniformly disposed in their respective magnetic devices.

Accordingly, the litz wire windings in magnetic devices 1400, 1500, 1600, and 1700 of FIGS. 14, 15, 16, and 17, respectively, are positioned to avoid regions where gap-induced, fringing magnetic flux is the strongest. It should be appreciated, however, that the litz wire windings in these magnetic devices could alternately be uniformly positioned without departing from the scope hereof.

Although the magnetic devices discussed above are illustrated as having rectangular-shaped magnetic cores, the magnetic devices are not limited to such magnetic core geometry. Indeed, the magnetic cores could have almost any cross-sectional geometry. Some possible magnetic cores that could potentially be used include ER, EP, ETD, EFD, RM, PQ, TT, EQ, PH, PM, and UR cores.

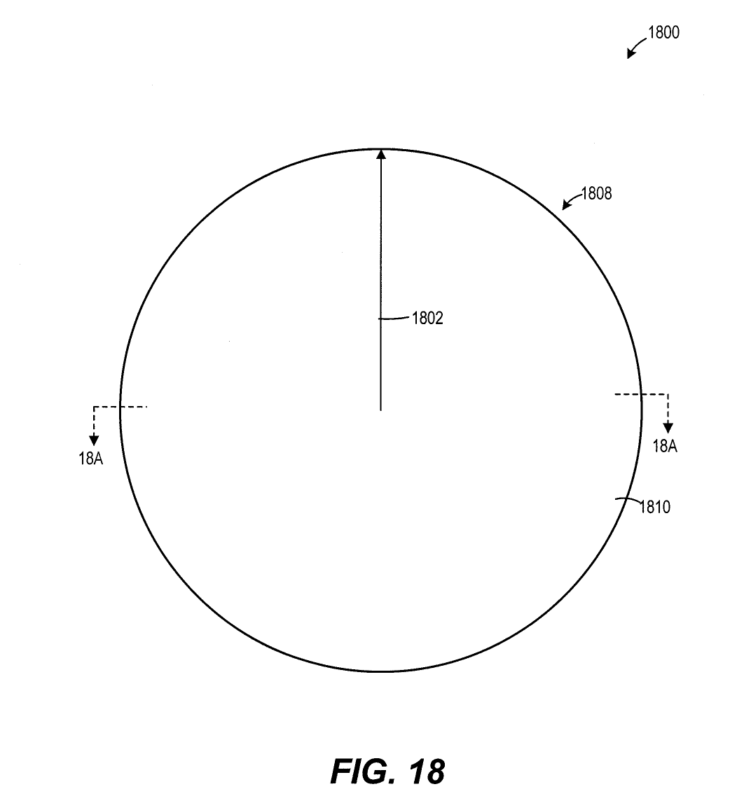

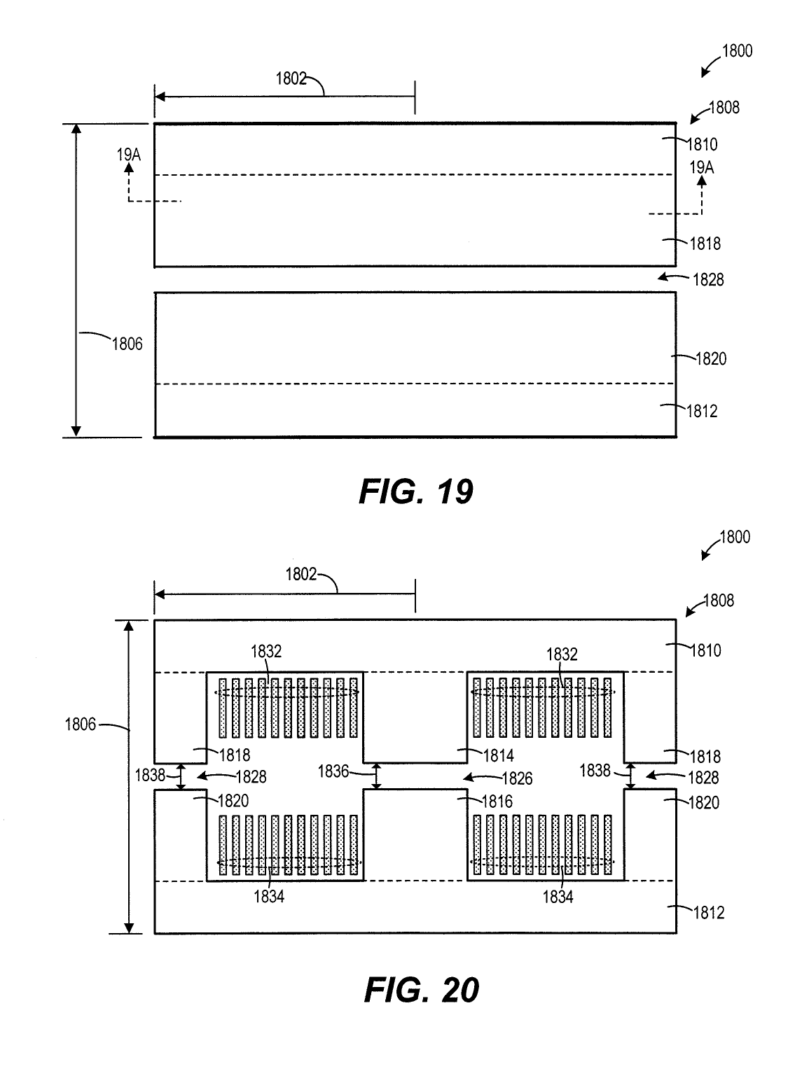

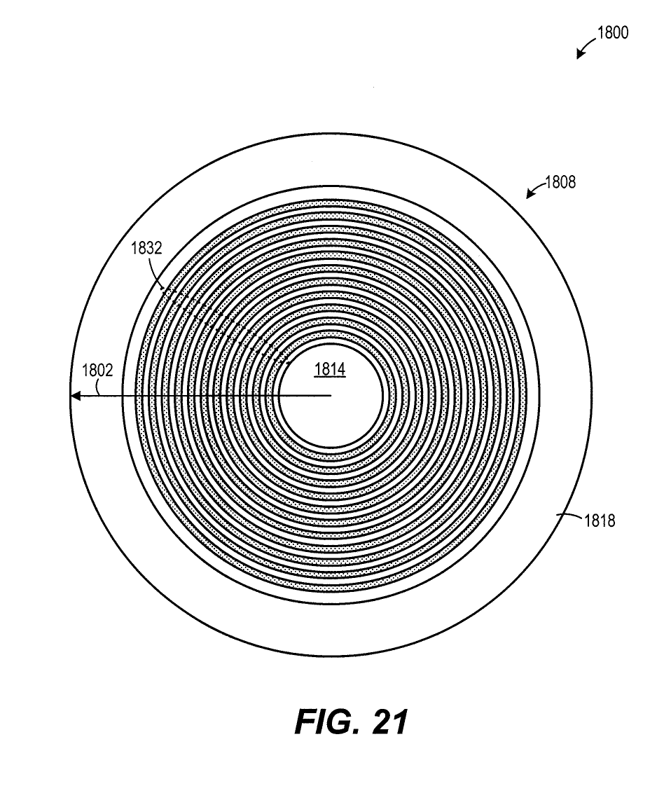

For example, FIG. 18 is a top plan view, and FIG. 19 is a side elevational view, of a magnetic device 1800 having a round pot magnetic core. Magnetic device 1800 is similar to magnetic device 300 of FIG. 3, except for the magnetic core shape. FIG. 20 is a vertical cross-sectional view of magnetic device 1800 taken along line 18A-18A of FIG. 18, and FIG. 21 is a horizontal cross-sectional view taken along line 19A-19A of FIG. 19. Magnetic device 1800 has a radius 1802 and a height 1806.

Magnetic device 1800 includes a pot magnetic core 1808 including round disk-shaped end pieces 1810 and 1812, cylindrical inner posts 1814 and 1816, and round outer elements 1818 and 1820. Inner posts 1814 and 1816 are coaxial and are separated from each other in the height 1806 direction by an inner gap 1826. Outer elements 1818 and 1820 are coaxial and are separated from each other in the height 1806 direction by an outer gap 1828. Inner post 1814 and outer element 1818 are concentric, and inner post 1816 and outer element 1820 are concentric.

Magnetic device 1800 further includes foil windings 1832 and 1834. Foil winding 1832 is wound around inner post 1814 without extending along heights 1836 and 1838 of inner gap 1826 and outer gap 1828, respectively. Similarly, foil winding 1834 is wound around inner post 1816 without extending along heights 1836 and 1838 of inner gap 1826 and outer gap 1828, respectively. Accordingly, magnetic device 1800 achieves low winding AC resistance in a manner similar to that discussed above with respect to FIG. 3.

### Combinations of Features

Features described above as well as those claimed below may be combined in various ways without departing from the scope hereof. The following examples illustrate some possible combinations:

(A1) A magnetic device having height may include a magnetic core, a first foil winding, and a second foil winding. The magnetic core may include (1) first and second inner posts separated from each other in the height direction by a first inner gap and (2) first and second outer elements separated from each other in the height direction by a first outer gap. The first foil winding may be wound around the first inner post without extending along a height of the first inner gap and without extending along a height of the first outer gap, and the second foil winding may be wound around the second inner post without extending along the height of the first inner gap and without extending along the height of the first outer gap.

(A2) In the magnetic device denoted as (A1), the first foil winding may form a plurality of first winding turns having respective first winding heights, and the second foil winding may form a plurality of second winding turns having respective second winding heights. The first winding turn instances located approximately midway between the first inner post and the first outer element may have maximum first winding height values, and the second winding turn instances located approximately midway between the second inner post and the second outer element may have maximum second winding height values.

(A3) The magnetic device denoted as (A1) may further include a litz wire winding wound around the first and second inner posts, where the litz wire winding separates the first and second foil windings in the height direction.

(A4) In any of the magnetic devices denoted as (A1) through (A3), the magnetic core may further include (1) a third inner post separated from the second inner post in the height direction by a second inner gap and (2) a third outer element separated from the second outer element in the height direction by a second outer gap. The magnetic device denoted as (A4) may further include a third foil winding wound around the third inner post without extending along a height of the second inner gap and without extending along a height of the second outer gap.

(A5) In any of the magnetic devices denoted as (A1) through (A3), the magnetic core may further include third and fourth outer elements separated from each other in the height direction by a second outer gap, the first foil winding may be wound around the first inner post without extending along a height of the second outer gap, and the second foil winding may be wound around the second inner post without extending along the height of the second outer gap.

(A6) In the magnetic devices denoted as (A5), the first outer element, the first inner post, and the third outer element may be offset from each other in a lengthwise direction orthogonal to the height direction, and the second outer element, the second inner post, and the fourth outer element may be offset from each other in the lengthwise direction.

(A7) In any of the magnetic devices denoted as (A1) through (A4), the first outer element may be offset from the first inner post in a lengthwise direction orthogonal to the height direction, and the second outer element may be offset from the second inner post in the lengthwise direction.

(A8) In any of the magnetic devices denoted as (A1) through (A4), each of the first and second outer elements may have a round shape and may be concentrically disposed around the first and second inner posts, respectively.

(A9) Any of the magnetic devices denoted as (A1) through (A4) may further include a third foil winding wound around the first outer element without extending along the height of the first inner gap and without extending along the height of the first outer gap, and a fourth foil winding wound around the second outer element without extending along the height of the first inner gap and without extending along the height of the first outer gap.

(A10) The magnetic device denoted as (A1) may further include a third foil winding wound around the first inner post without extending along the height of the first inner gap and without extending along the height of the first outer gap, and a fourth foil winding wound around the second inner post without extending along the height of the first inner gap and without extending along the height of the first outer gap.

(A11) In the magnetic device denoted as (A10), the third foil winding may be wound around the first foil winding such that the first and third foil windings are concentric, and the fourth foil winding may be wound around the second foil winding such that the second and fourth foil windings are concentric.

(B1) A magnetic device having height may include (1) a magnetic core including a plurality of inner posts, adjacent inner posts separated from each other in the height direction by a respective inner gap, (2) a first litz wire winding wound around the plurality of inner posts, and (3) a foil winding wound around the first litz wire winding.

(B2) In the magnetic device denoted as (B1), the plurality of inner posts, the first litz wire winding, and the foil winding may be concentric.

(B3) In either of the magnetic devices denoted as (B1) or (B2), the magnetic core may further include a plurality of outer elements, adjacent outer elements separated from each other in the height direction by a respective outer gap, and the magnetic device may further include a second litz wire winding wound around the foil winding.

(C1) A magnetic device having height may include a magnetic core and a foil winding. The magnetic core may include (1) first and second end pieces separated from each other in the height direction, (2) an inner post separated from the first end piece in the height direction by an inner gap, and (3) a first outer element separated from the first end piece in the height direction by a first outer gap. The first foil winding may be wound around the inner post, where the foil winding is separated from the first end piece by a first separation distance in the height direction, the foil winding is separated from the second end piece by a second separation distance in the height direction, and the first separation distance is greater than the second separation distance.

(C2) In the magnetic device denoted as (C1), the foil winding may be wound around the inner post such that the foil winding does not extend along a height of the first outer gap and such that the foil winding does not extend along a height of the inner gap.

(C3) Either of the magnetic devices denoted as (C1) or (C2) may further include a second outer element separated from the first end piece in the height direction by a second outer gap, where the foil winding is wound around the inner post such that the foil winding does not extend along a height of the second outer gap.

Changes may be made in the above methods and systems without departing from the scope hereof. For example, magnetic devices 700, 900, 1000, 1100, 1200, 1300, 1400, 1500, 1600, 1700, 2200, 2300, 2400, and 2600 could be modified to have a round magnetic core in a manner similar to that of magnetic device 1800 without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A magnetic device having height, the magnetic device comprising:
a magnetic core, including:
first and second inner posts separated from each other in the height direction by a first inner gap, and
first and second outer elements separated from each other in the height direction by a first outer gap;
a first foil winding wound around the first inner post without extending along a height of the first inner gap and without extending along a height of the first outer gap; and
a second foil winding wound around the second inner post without extending along the height of the first inner gap and without extending along the height of the first outer gap.

2. The magnetic device of claim 1, the first foil winding forming a plurality of first winding turns having respective first winding heights, the second foil winding forming a plurality of second winding turns having respective second winding heights, wherein:
first winding turn instances located approximately midway between the first inner post and the first outer element have maximum first winding height values; and
second winding turn instances located approximately midway between the second inner post and the second outer element have maximum second winding height values.

3. The magnetic device of claim 1, further comprising a litz wire winding wound around the first and second inner posts, the litz wire winding separating the first and second foil windings in the height direction.

4. The magnetic device of any one of claims 1-3, wherein:
the magnetic core further includes:
a third inner post separated from the second inner post in the height direction by a second inner gap, and
a third outer element separated from the second outer element in the height direction by a second outer gap; and
the magnetic device further comprises a third foil winding wound around the third inner post without extending along a height of the second inner gap and without extending along a height of the second outer gap.

5. The magnetic device of any one of claims 1-3, wherein:
the magnetic core further includes third and fourth outer elements separated from each other in the height direction by a second outer gap;
the first foil winding is wound around the first inner post without extending along a height of the second outer gap; and
the second foil winding is wound around the second inner post without extending along the height of the second outer gap.

6. The magnetic device of claim 5, wherein:
the first outer element, the first inner post, and the third outer element are each offset from each other in a lengthwise direction orthogonal to the height direction; and
the second outer element, the second inner post, and the fourth outer element are each offset from each other in the lengthwise direction.

7. The magnetic device of any one of claims 1-4, wherein:
the first outer element is offset from the first inner post in a lengthwise direction orthogonal to the height direction; and
the second outer element is offset from the second inner post in the lengthwise direction.

8. The magnetic device of any one of claims 1-4, each of the first and second outer elements having a round shape and being concentrically disposed around the first and second inner posts, respectively.

9. The magnetic device of any one of claims 1-4, further comprising:
a third foil winding wound around the first outer element without extending along the height of the first inner gap and without extending along the height of the first outer gap; and
a fourth foil winding wound around the second outer element without extending along the height of the first inner gap and without extending along the height of the first outer gap.

10. The magnetic device of claim 1, further comprising:
a third foil winding wound around the first inner post without extending along the height of the first inner gap and without extending along the height of the first outer gap; and
a fourth foil winding wound around the second inner post without extending along the height of the first inner gap and without extending along the height of the first outer gap.

11. The magnetic device of claim 10, wherein:
the third foil winding is wound around the first foil winding such that the first and third foil windings are concentric; and
the fourth foil winding is wound around the second foil winding such that the second and fourth foil windings are concentric.

12. A magnetic device having height, the magnetic device comprising:
a magnetic core including a plurality of inner posts, adjacent inner posts separated from each other in the height direction by a respective inner gap;
a first litz wire winding wound around the plurality of inner posts; and
a foil winding wound around the first litz wire winding.

13. The magnetic device of claim 12, the plurality of inner posts, the first litz wire winding, and the foil winding being concentric.

14. The magnetic device of claim 12 or 13, wherein:
the magnetic core further comprises a plurality of outer elements, adjacent outer elements separated from each other in the height direction by a respective outer gap; and
the magnetic device further comprises a second litz wire winding wound around the foil winding.

15. A magnetic device having length and height, the magnetic device comprising:
a magnetic core including first and second inner posts separated from each other in the height direction by a first inner gap;
a first foil winding wound around the first inner post, the first foil winding forming a plurality of first winding turns, respective heights of the first winding turns increasing with increasing lengthwise distance from the first inner post; and
a second foil winding separated from the first foil winding in the height direction, the second foil winding wound around the second inner post, the second foil winding forming a plurality of second winding turns, respective heights of the second winding turns increasing with increasing lengthwise distance from the second inner post.

16. A magnetic device having height, the magnetic device comprising:
a magnetic core, including:
first and second end pieces separated from each other in the height direction,
an inner post separated from the first end piece in the height direction by an inner gap, and
a first outer element separated from the first end piece in the height direction by a first outer gap; and
a foil winding wound around the inner post, the foil winding separated from the first end piece by a first separation distance in the height direction, the foil winding separated from the second end piece by a second separation distance in the height direction, the first separation distance being greater than the second separation distance.

17. The magnetic device of claim 16, the foil winding wound around the inner post such that the foil winding does not extend along a height of the first outer gap and such that the foil winding does not extend along a height of the inner gap.

18. The magnetic device of claim 17, further comprising:
a second outer element separated from the first end piece in the height direction by a second outer gap; and
the foil winding wound around the inner post such that the foil winding does not extend along a height of the second outer gap.
